(19) United States
(12) Patent Application Publication
(10) Pub. No.: US 2016/0012399 A1
(43) Pub. Date: Jan. 14, 2016

(54) SECURE TWO-STAGE TRANSACTIONS

(71) Applicant: UNILOC LUXEMBOURG S.A., Luxembourg (LU)

(72) Inventor: Craig S. ETCHEGOYEN, Plano, TX (US)

(21) Appl. No.: 14/794,121

(22) Filed: Jul. 8, 2015

Related U.S. Application Data
(60) Provisional application No. 62/022,554, filed on Jul. 9, 2014.

(51) Int. Cl. G06Q 20/10; G07F 19/00; G06Q 20/40; H04L 29/06; G06Q 20/20

(52) U.S. Cl. CPC G06Q 20/1085; H04L 63/0876; H04L 63/0807; H04L 63/0853; H04L 63/0435; H04L 63/0492; G06Q 20/202; G06Q 20/401; G07F 19/203

(57) ABSTRACT

A transaction server authenticates a client device during a fulfillment phase of a transaction as having authorized the transaction using cryptographic data sent to the device during an authorization phase of the transaction. In particular, prior to fulfilling the transaction through point-of-sale equipment, the transaction server requires that the device successfully decrypt a transaction token using a transaction key sent to the device during authorization of the transaction.

### BACKGROUND OF THE INVENTION

1. Field of the Invention

The present invention relates generally to computer systems and, more particularly, to methods of and systems for carrying out transactions through a computer network, including an authorization phase and a fulfillment phase.

2. Description of the Related Art

In recent years, there have been several notable security failures at points of sale in which point-of-sale equipment has been compromised, resulting in theft of massive amounts of purchaser credentials. The manner in which millions of purchases are conducted daily is no longer secure. A particularly sensitive scenario is a cash withdrawal from an ATM. With stolen credentials, a thief could withdraw substantial sums of a victim's cash from any of a multitude of locations.

What is needed is a way to more securely carry out authorization and fulfillment of transactions.

### SUMMARY OF THE INVENTION

In accordance with the present invention, a transaction server authenticates a client device during a fulfillment phase of a transaction as having authorized the transaction using cryptographic data sent to the device during an authorization phase of the transaction. In particular, prior to fulfilling the transaction through point-of-sale equipment, the transaction server requires that the device successfully decrypt a transaction token using a transaction key sent to the device during authorization of the transaction.

It is helpful to consider an example in which the transaction is a cash withdrawal from a bank account and the point-of-sale equipment is an automated teller machine (ATM). In a first session with the transaction server in which the transaction is authorized, the user is authenticated and uses the device to submit a request for the transaction. Upon authentication of the user and the device and validation of the transaction request, the transaction server sends a transaction identifier and a transaction key to the device.

In a second session in which the transaction is fulfilled, the user retrieves the transaction identifier from the device and enters the transaction identifier into point-of-sale equipment, which then sends the transaction identifier to the transaction server. To verify that the device is the same device through which the transaction was authorized, the transaction server encrypts a transaction token in a manner that decryption and recovery of the transaction token requires the transaction key sent to the device in the first, authorization session. In particular, the transaction server encrypts the transaction token with the transaction key. The transmission server also uses a transaction initiation vector (IV) to encrypt the transaction token.

The transaction server sends the encrypted transaction token and the transaction IV to the device. For example, the transaction server can send the data to the point-of-sale equipment for communication to the device, e.g., by display of a QR code that can be captured and decoded by the device.

The device decrypts the transaction token using both the transaction key received during the first, authorization session and the transaction IV received during the second, fulfillment session and displays the resulting transaction token to the user. The user enters the transaction token into the point-of-sale equipment, e.g., by use of an ATM keypad.

If the transaction token matches the one encrypted by the transmission server, the transmission server has determined that the device attempting fulfillment of the transaction is the same device that authorized the transaction and effects the transaction. For example, the transmission server can effect the transaction by causing the point-of-sale equipment (e.g. the ATM) to dispense cash in the amount specified in the transaction request.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a computing device, point-of-sale equipment, and a transaction server that cooperate to conduct a transaction in accordance with one embodiment of the present invention.

FIG. 2A is a transaction flow diagram summarizing the manner in which the device cooperates with the transaction server to authorize the transaction in a first session.

FIG. 2B is a transaction flow diagram summarizing the manner in which the device cooperates with the transaction server to fulfill the transaction in a second session.

FIG. 3 is a transaction flow diagram illustrating in detail the manner in which the device cooperates with the transaction server to authorize the transaction in a first session.

FIG. 4 is a block diagram of a transaction record used by the transaction server to manage the transaction.

FIGS. 5A and 5B together show a transaction flow diagram illustrating in detail the manner in which the device cooperates with the transaction server to fulfill the transaction in a second session.

FIG. 6 is a block diagram showing in greater detail the point-of-sale equipment of FIG. 1.

FIG. 7 is a block diagram showing in greater detail the transaction server of FIG. 1.

FIG. 8 is a block diagram showing in greater detail the device of FIG. 1.

### DETAILED DESCRIPTION

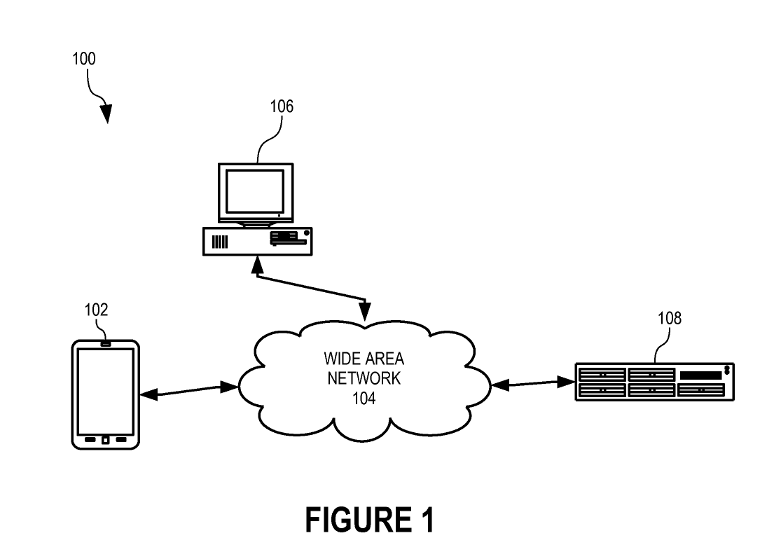

In accordance with the present invention, a transaction server 108 (FIG. 1) authenticates a computing device 102 during a fulfillment phase of a transaction as having authorized the transaction using cryptographic data sent to device 102 during an authorization phase of the transaction. In particular, prior to fulfilling the transaction through point-of-sale equipment 106, transaction server 108 requires that device 102 successfully decrypt a transaction token using a transaction key sent to device 102 during authorization of the transaction.

Transaction fulfillment system 100 includes device 102, point-of-sale equipment 106, and transaction server 108 that are connected to one another through a wide area computer network 104, which is the Internet in this illustrative embodiment. Device 102 can be any of a number of types of networked, mobile computing devices, including smart phones, tablets, netbook computers, and laptop computers. Point-of-sale equipment 106 is a device with which financial transactions can be effected. Examples of point-of-sale equipment 106 include credit card terminals and automated teller machines (ATMs). Transaction server 108 is a server that manages financial transactions that can be fulfilled through point-of-sale equipment 106. For example, if point-of-sale equipment 106 is an ATM, transaction server 108 manages bank transactions. If point-of-sale equipment 106 is a credit card terminal at a store, transaction server 108 manages on-line purchases of merchandise that can be picked up at the store.

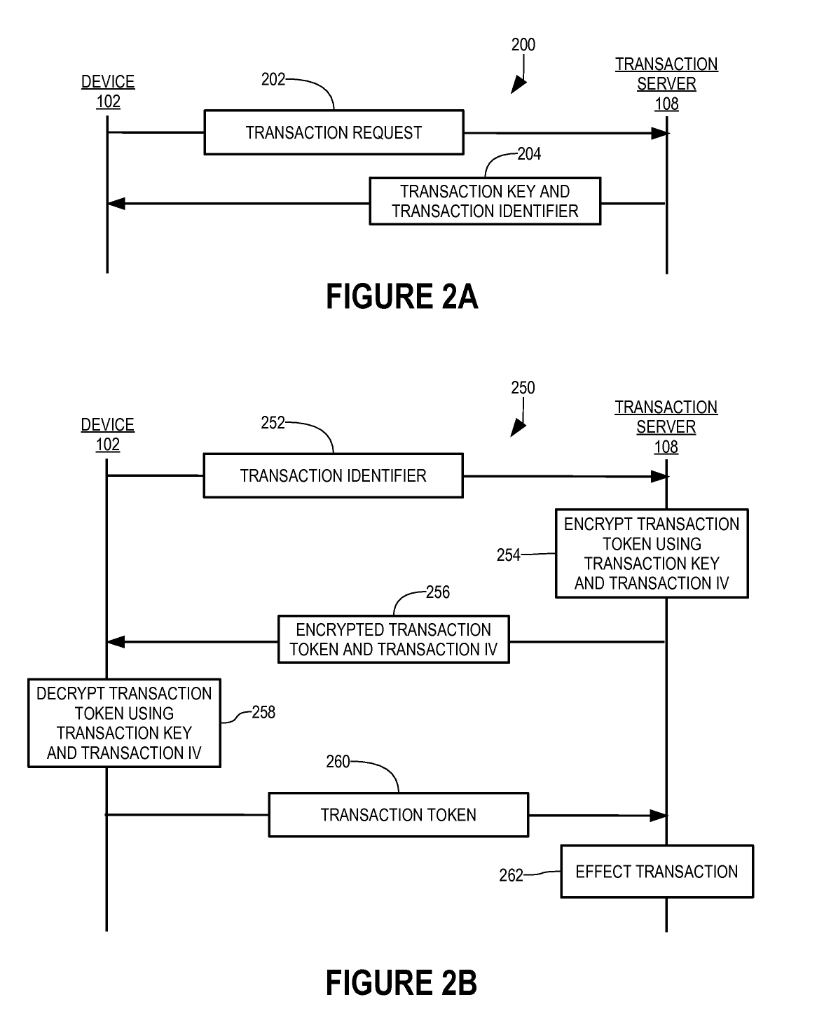

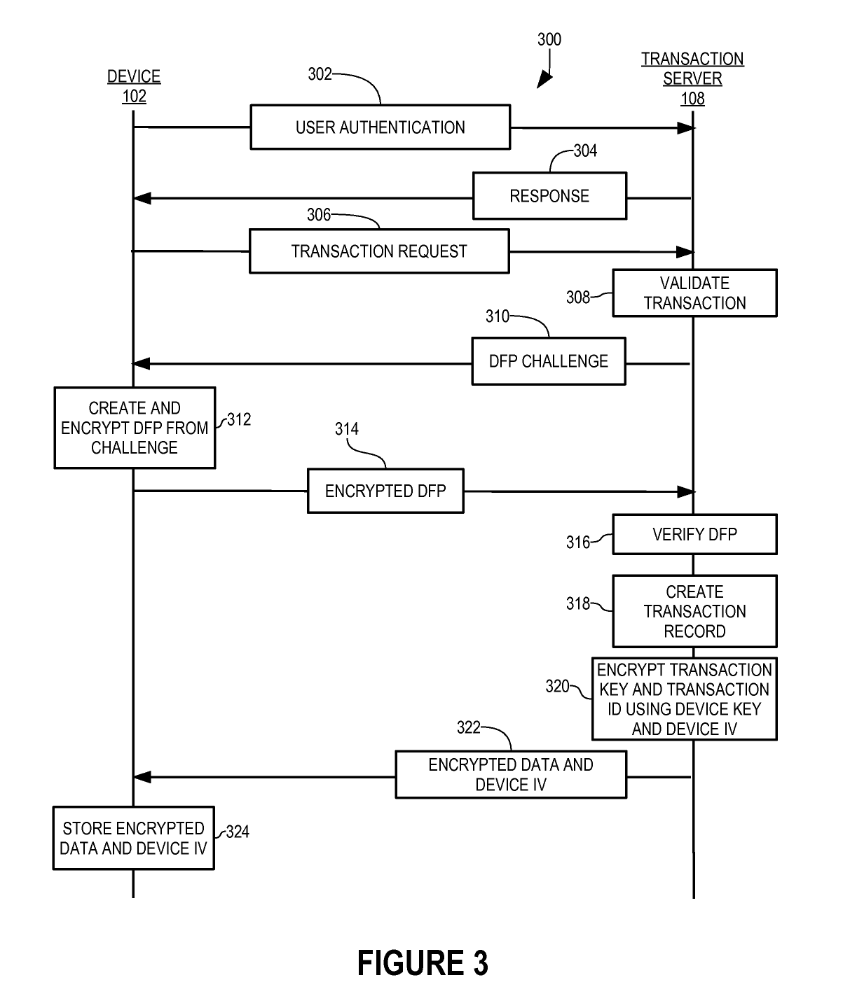

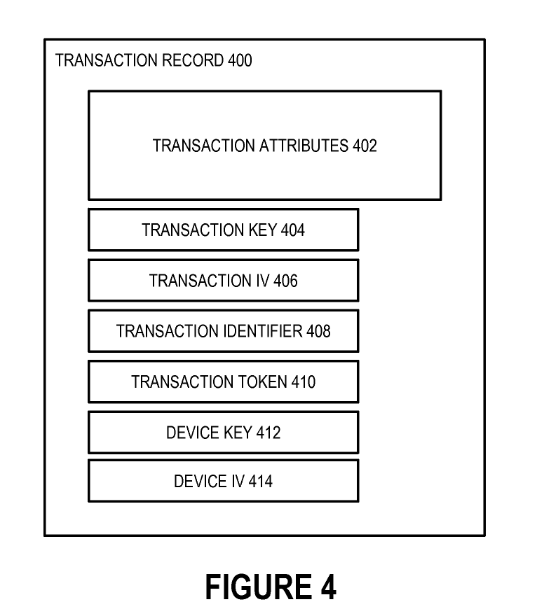

Transaction flow diagram 200 (FIG. 2A) summarizes authorization of a transaction in a manner described more completely below in conjunction with FIG. 3. In step 202, device 102 sends a request for a transaction to transaction server 108. The request specifies the details of the proposed transaction. For example, if the transaction is purchase of merchandise to be picked up at a store, the request specifies the merchandise to be purchased, the store at which the merchandise is to be picked up, and data specifying a method of payment for the merchandise such as credit card information or back account information. If the transaction is a cash withdrawal from an ATM, the request specifies the account from which to withdraw cash, the amount of cash, the particular ATM from which cash is to be dispensed, and authentication data.

In step 204 (FIG. 2A), transaction server 108 sends a transaction key and a transaction identifier to device 102. The transaction key is used during a fulfillment phase of the transaction to authenticate device 102 as the device that authorized the transaction. The transaction identifier is a token by which the user can identify the transaction through point-of-sale equipment 106 during fulfillment of the transaction.

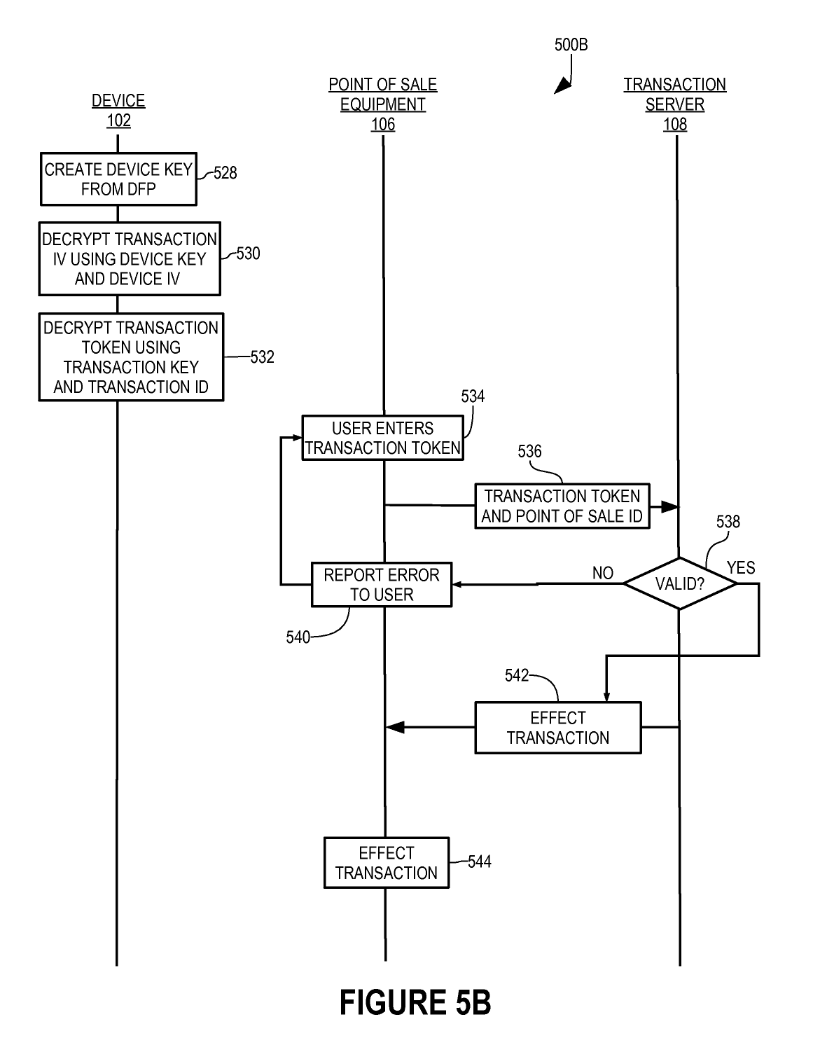

Transaction flow diagram 250 (FIG. 2B) summarizes fulfillment of the transaction in a manner described more completely below in conjunction with FIGS. 5A-B. In step 252, transaction server 108 receives the transaction identifier. In response, transaction server 108 encrypts a transaction token using the transaction key sent in step 204 (FIG. 2A) and a transaction initialization vector (IV) in step 254.

An initialization vector is an additional encryption key, like a nonce or salt used in conventional encryption. Encrypting the transaction token with both the transaction key and the transaction IV results in both the transaction key and the transaction IV being required to decrypt the transaction token.

In step 256, transaction server 108 sends the encrypted transaction token and the transaction IV to device 102. In step 258, device 102 uses both the transaction IV received in step 256 and the transaction key received in step 204 (FIG. 2A) to decrypt the transaction token.

In step 260 (FIG. 2B), transaction server 108 receives the decrypted transaction token. If device 102 successfully decrypts the transaction token, transaction server 108 has determined that device 102 is the device that authorized the transaction identified by the transaction identifier. In response to such a determination, transaction server 108 effects the transaction in step 262.

Thus, the transaction key and transaction IV are both required to decrypt and recover the transaction token and therefore collectively authenticate device 102 as the device participating in both the authorization session and the fulfillment session. While it is described that the transaction key is delivered to device 102 during the authentication session and the transaction IV is delivered to device 102 during the fulfillment session, it should be appreciated that the transaction IV can be delivered during the authorization session and the transaction key can be delivered during the fulfillment session.

Logic flow diagram 300 (FIG. 3) shows authorization of a financial transaction as summarized in logic flow diagram 200 (FIG. 2A). In step 302 (FIG. 3), device 102 sends user authentication data to transaction server 108. In this illustrative embodiment, device 102 and the user thereof may be authenticated in a manner described, for example, in U.S. patent application Ser. No. 13/832,982 (hereinafter referred to as the '982 Application) and that description is incorporated herein by reference.

Upon successful authentication of the user and device 102, transaction server 108 sends a response so indicating to device 102 in step 304. In step 306, device 102 sends a transaction request to transaction server 108.

The transaction request specifies a financial transaction that the user would like to conduct. For example, the transaction can be a cash withdrawal at a specific ATM. In this example, the transaction request can specify a bank account from which the cash is to be withdrawn, an amount to be withdrawn, and the specific ATM to dispense the cash. The transaction can also be a purchase of merchandise to be received at a specific store location. In that example, the transaction request can specify a payment method (such as credit card billing information for example), merchandise to be purchased, and the specific store location at which the merchandise will be received.

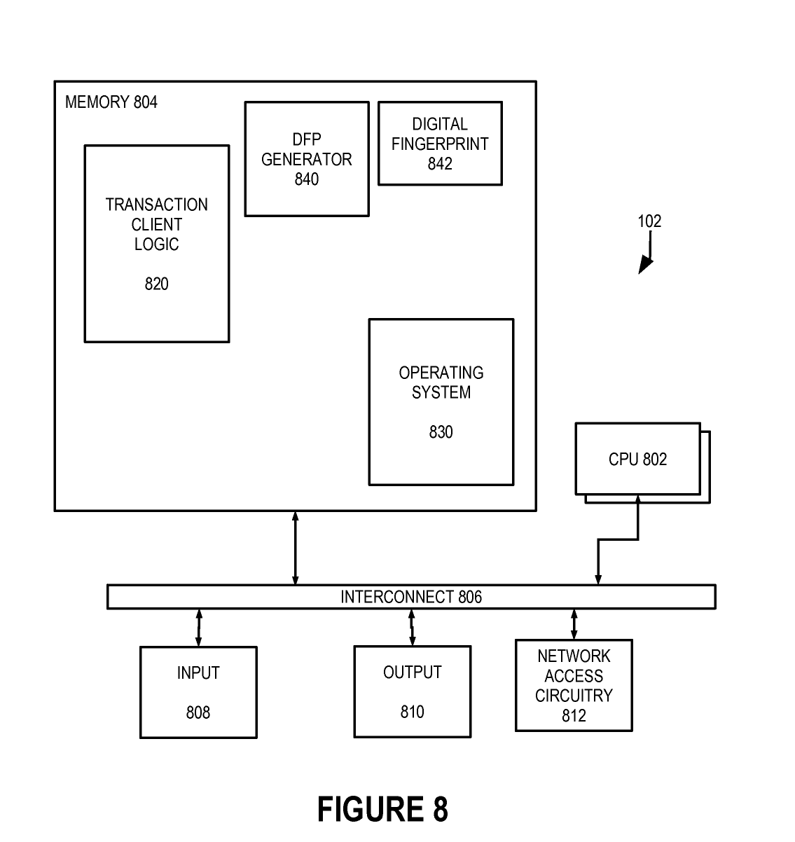

As described more completely below, device 102 includes transaction client logic 820 (FIG. 8) and user input devices 808 and user output devices 810. The user specifies a transaction to be conducted using transaction client logic 820, which employs user interface techniques involving presentation of prompting information through user output devices 810 and responsive data generated by physical manipulation of user input devices 808 by the user.

In response to receipt of the transaction request in step 306 (FIG. 3), transaction server 108 validates the requested transaction in step 308. The manner in which transaction server 108 validates the requested transaction depends upon the particular type of transaction requested. For example, if the requested transaction is a cash withdrawal from an ATM, transaction server 108 validates the transaction by determining that the bank account has sufficient funds to cover the requested cash withdrawal and that the user is authorized to access that account. If the requested transaction is a purchase of merchandise to be picked up at a specific store location, transaction server 108 validates the transaction by determining that the specified payment method can effect payment in the amount of the purchase total and that the merchandise to be purchased is in stock at the specified store location.

If transaction server 108 determines that the requested transaction is not valid, transaction server 108 denies the request. In this illustrative embodiment, transaction server 108 informs device 102 of the denial and transaction client logic 820 (FIG. 8) reports the denial to the user and provides the user with an opportunity to modify the transaction to request from transaction server 108 in a repeated performance of step 306 (FIG. 3).

If transaction server 108 determines that the requested transaction is valid, processing transfers to step 310 in which transaction server 108 sends a digital fingerprint challenge to device 102. Digital fingerprints are described in greater detail in the '982 Application but are briefly described here for completeness. For device and user authentication using digital fingerprints, device 102 has previously registered with transaction server 108, providing a number of device and user attributes that can be used in combination for such authentication. The device challenge sent in step 310 specifies both (i) a number of those attributes to be collected and (ii) a manner in which those attributes are to be combined into, and represented within, a digital fingerprint.

By using different challenges in separate acts of authentication, snooping network traffic for such challenges and corresponding responsive digital fingerprints does not provide sufficient information to allow another device to spoof being device 102 by properly responding to a future digital fingerprint challenge. Specifically, the future digital fingerprint challenge will very likely differ from any previous challenges that might have been intercepted, so the proper response for device 102 will be different from any responses that might have been intercepted.

In step 312, digital fingerprint generator 840 (FIG. 8) generates digital fingerprint 842 in the manner specified in the digital fingerprint challenge sent in step 310 (FIG. 3) and encrypts digital fingerprint 842, e.g., using a public key of transaction server 108 and public-key infrastructure (PKI). In step 314, device 102 sends the encrypted digital fingerprint to transaction server 108.

In step 316, transaction server 108 verifies the digital fingerprint to authenticate device 102 and its user. Transaction server 108 verifies the digital fingerprint by applying the digital fingerprint challenge sent in step 310 to device and user attributes received from device 102 during prior registration and comparing the result to the received digital fingerprint.

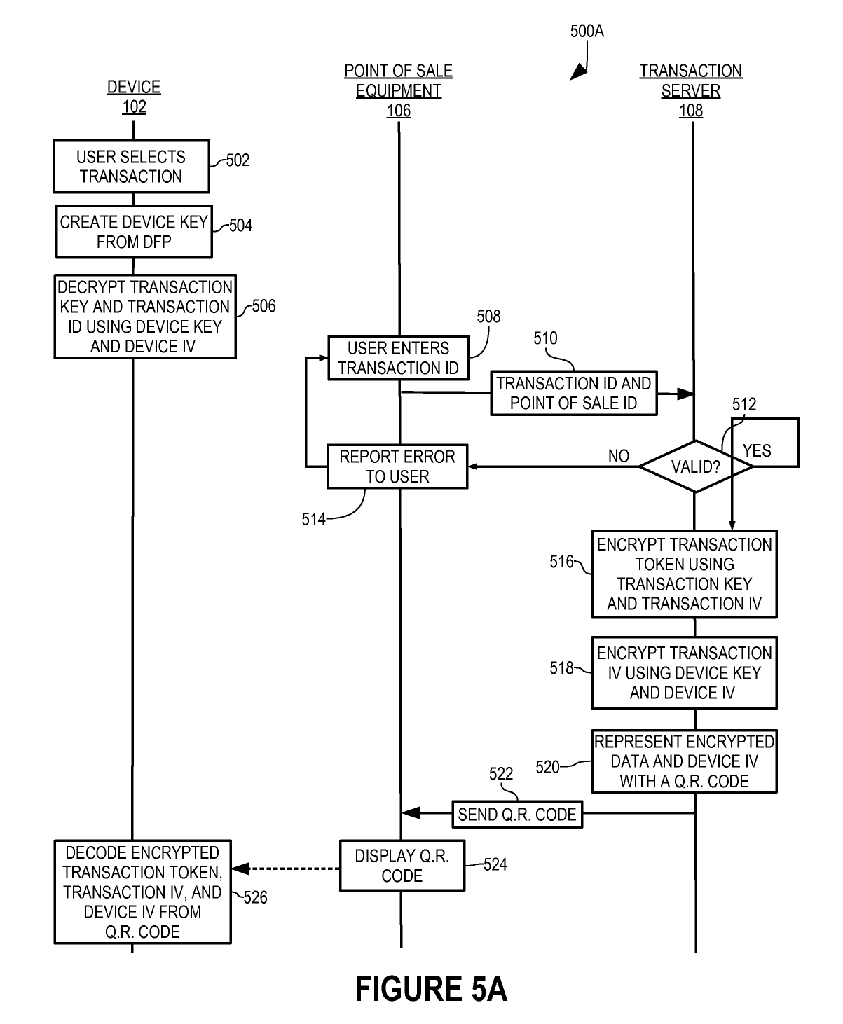

If the received digital fingerprint does not authenticate device 102, transaction server 108 denies the transaction requested in step 306. Conversely, if the received digital fingerprint authenticates device 102, transaction server 108 continues with step 318, creating a transaction record such as transaction record 400 (FIG. 4) to manage the requested transaction.

Transaction record 400 includes transaction attributes 402 that collectively represent the transaction requested in step 306 (FIG. 3). Transaction key 404 is a symmetric key for encryption and decryption. Transaction IV 406 is a cryptographic initialization vector to be used with transaction key 404.

Transaction identifier 408 is an identifier of the transaction represented by transaction record 400. Transaction token 410 is data that must be presented by the user in the fulfillment phase to complete the transaction.

Device key 412 and device IV 414 are an encryption key and initialization vector, respectively, that are unique to device 102. Device key 412 is derived from the digital fingerprint received in step 314 (FIG. 3) in a manner that can be replicated by device 102.

In step 320, transaction server 108 encrypts transaction key 404 and transaction identifier 408 using device key 412 and device IV 414. In step 322, transaction server 108 sends the results of the encryption of step 320 and device IV 414 to device 102. In step 324, device 102 stores the data received in step 322 for use in the fulfillment phase of the transaction.

Logic flow diagrams 500A (FIG. 5A) and 500B (FIG. 5B) collectively illustrate the fulfillment phase of the transaction as summarized in FIG. 2B. During the fulfillment phase of the transaction, the user of device 102 is physically present at, and is using, point-of-sale equipment 106. In this illustrative embodiment, device 102 is not required to be connected to either point-of-sale equipment 106 or transaction server 108 through any computer network.

In step 502 (FIG. 5A), the user expresses an intent to start the fulfillment phase of the transaction using transaction client logic 820 (FIG. 8) and user interface techniques involving user input devices 808 and user output devices 810.

In step 504 (FIG. 5A), device 102 creates a device key from digital fingerprint 842 (FIG. 8) in the same manner that transaction server 108 created device key 412 from the same digital fingerprint. Accordingly, the device key created by device 102 in step 504 is equivalent to device key 412.

In step 506, device 102 decrypts transaction key 404 and transaction identifier 408 from the encrypted data stored in step 324 using the device key created in step 504 and device IV 414, which was stored in step 324. Thus, transaction key 404 and transaction identifier 408 are recovered by device 102 without receiving device key 412 from transaction server 108. In addition, since device 102 derives the device key from digital fingerprint 842, which was derived from attributes of device 102, the proper device key cannot be derived by any device other than device 102. Device 102 presents transaction identifier 408 to the user using user output devices 810.

In step 508, the user enters transaction identifier 408 into point-of-sale equipment 106, e.g., using a keypad or other user input device 608 of point-of-sale equipment 106. In step 510, point-of-sale equipment 106 sends transaction identifier 408 and an identifier of the location of point-of-sale equipment 106.

In this illustrative embodiment, transactions are specific to a location at which fulfillment of the transaction is to be performed. To illustrate the advantage of location-specific transactions, it is helpful to consider the example of cash withdrawals from ATMs in a network of thousands of ATMs. At any given time, there may be thousands of authorized but not yet fulfilled transactions throughout the network of ATMs but each ATM location might have just a few such transactions. In addition, since the user manually enters the transaction identifier, particularly long transaction identifiers increase the difficulty with which users can accurately enter the transaction identifier.

Suppose an unscrupulous user at an ATM enters randomly guessed transaction identifiers in an attempt to intercept cash authorized for withdrawal by another. If the ATM is authorized to fulfill any pending transaction for any ATM in the network, the unscrupulous user must guess any one of thousands of pending transactions. If transaction identifiers are only six (6) digits in length, the odds are rather good that the unscrupulous user can successfully guess the identifier of a pending transaction. However, the ATM can only fulfill pending transactions that are associated with that ATM location, the unscrupulous user must guess any one of perhaps just a few pending transactions. The odds that the unscrupulous user can successfully guess the identifier of a pending transaction are far, far less.

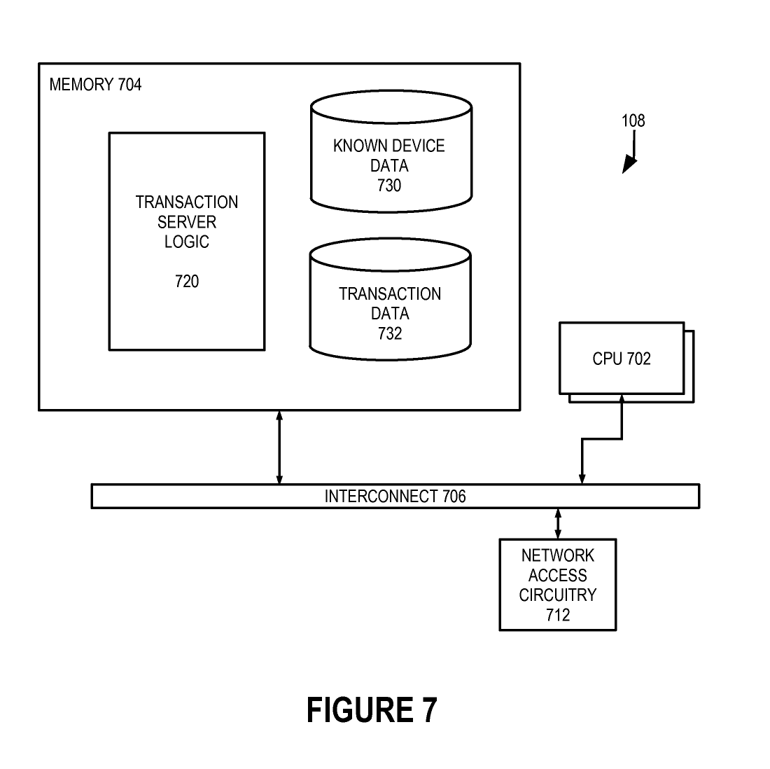

In step 512, transaction server 108 validates the transaction identifier and the location of point-of-sale equipment 106. In particular, transaction server 108 searches transaction data 732 (FIG. 7) for a transaction identifier 400 (FIG. 4) whose transaction identifier 408 matches the received transaction identifier and whose transaction attributes 402 specify the location of point-of-sale equipment 106. If the transaction identifier and the location of point-of-sale equipment 106 are not valid, i.e., do not correspond to a pending transaction, transaction server 108 causes point-of-sale equipment 106 to report the error to the user in step 514, and the user is provided an opportunity to enter the transaction identifier accurately in step 508. In this illustrative embodiment, the user is provided with a limit number of opportunities to enter the transaction identifier accurately before transaction server 108 terminates the transaction.

If the transaction identifier and the location of point-of-sale equipment 106 are valid, i.e., correspond to a pending transaction, processing by transaction server 108 transfers to step 516. In step 516, transaction server 108 encrypts transaction token 410 using transaction key 404 and transaction IV 406. In step 518, transaction server 108 encrypts transaction IV 406 using device key 412 and device IV 414.

In step 520, transaction server 108 represents the results of encryption of steps 516 and 518, along with device IV 414, in an optical code that can be recognized and parsed by device 102. In this illustrative embodiment, the optical code is a QR (Quick Response) code. QR codes are known and not described herein.

In step 522, transaction server 108 sends the QR code to point-of-sale equipment 106 and, in step 524, point-of-sale equipment displays the QR code to the user.

In step 526, the user captures the displayed QR code with device 102, e.g., using a camera of device 102, and device 102 decodes the QR code to retrieve the resulting encrypted data of steps 516 and 518 and device IV 414.

In step 528 (FIG. 5B), device 102 creates a device key from digital fingerprint 842 (FIG. 8) in the manner described above with respect to 504 (FIG. 5A). In step 530 (FIG. 5B), device 102 decrypts transaction IV 406 from the received encrypted data using the device key created in step 528 and device IV 414, which was decoded from the QR code in step 526 (FIG. 5A).

At this point, device 102 has transaction key 404 (decrypted in step 506) and transaction IV 406 (decrypted in step 530). The data from which transaction key 404 is decrypted is received from transaction server 108 during the authorization phase of the transaction. The data from which transaction IV 406 is decrypted is received during the fulfillment phase of the transaction. Accordingly, device 102 must be used in both phases of the transaction to acquire both transaction key 404 and transaction IV 406.

In step 532, device 102 decrypts transaction token 410 from the received encrypted data using transaction key 404 and transaction IV 406 and presents transaction token 410 to the user, e.g., through any of user output devices 810 (FIG. 8).

In step 534, the user enters transaction token 410 into point-of-sale equipment 106, e.g., using a keypad or other user input device 608 of point-of-sale equipment 106. In step 536, point-of-sale equipment 106 sends transaction token 410 and an identifier of the location of point-of-sale equipment 106.

In step 538, transaction server 108 validates the received transaction token and the location of point-of-sale equipment 106 as both corresponding to the particular transaction record 400 identified by the transaction identifier received in step 510 (FIG. 5A). If the transaction token and location of point-of-sale equipment 106 are determined by transaction server 108 to be valid, transaction server 108 instructs, in step 542, point-of-sale equipment 106 to effect the transaction. In response to the instruction, point-of-sale equipment 106 effects the transaction in step 544. If point-of-sale equipment 106 is an ATM, point-of-sale equipment 106 effects the transaction in step 544 by dispensing the withdrawn cash. If point-of-sale equipment 106 is a store, point-of-sale equipment 106 effects the transaction in step 544 by authorizing the user to take possession of the purchased merchandise.

If the transaction token and location of point-of-sale equipment 106 are determined by transaction server 108 to be invalid, transaction server 108 causes point-of-sale equipment 106 to report the error to the user in step 540 and processing by point-of-sale equipment 106 transfers to step 534 to accept re-entry of the transaction token by the user. In an alternative embodiment, processing transfers from step 540 to step 522 (FIG. 5A) and the QR code is redisplayed for decoding by device 102.

While the illustrative embodiment described above does not require device 102 to be connected to a network during the fulfillment phase of the transaction, it should be appreciated that device 102 can be connected to wide area network 104 and communicate directly with transaction server 108 during fulfillment of the transaction. In this alternative embodiment, device 102 can identify point-of-sale equipment 106 from other, co-located point-of-sale equipment through an identifier that the user can enter into device 102 or that can be captured and decoded by device 102, e.g., as represented by a QR code. Transaction key 404 and transaction token 406 can be sent directly from device 102 to transaction server 108 without requiring that the user enter them in steps 508 and 534, respectively. Transaction server 108 can infer the location of point-of-sale equipment 106 from the identifier thereof received from device 102 or by determining that device 102 is connected to a local area network (LAN) with a known location.

Even if device 102 is not connected to a computer network, user error in steps 508 and 534 can be reduced by including in point-of-sale equipment 106 the ability to capture and decode QR codes. In this alternative embodiment, manual entry of the transaction identifier in step 508 is replaced with display by device 102 of a QR code representing the transaction identifier and positioning of device 102 by the user in a location at which a camera of point-of-sale equipment 106 can capture the QR code. Similarly, manual entry of the transaction token in step 534 is replaced with display by device 102 of a QR code representing the transaction token and positioning of device 102 by the user in a location at which a camera of point-of-sale equipment 106 can capture the QR code.

It should also be appreciated that different device keys can be used at various steps for added security. In the illustrative example described above, digital fingerprint 842 (FIG. 8) is created in step 312 (FIG. 3) and can remain unchanged as device key 412 is created therefrom in steps 318, 504 (FIG. 5A), and 528 (FIG. 5B). In one alternative embodiment, device key 412 is re-created in step 518 in a manner (i) that is different from that in which device key 412 is created in step 318 and (ii) that is known to device 102. In step 528, device 102 creates the device key using this different manner.

In another alternative embodiment, transaction server 108 creates a second device key in step 518 according to a second digital fingerprint challenge. Transaction server 108 communicates the second digital fingerprint challenge to device 102 through the QR code sent in step 522. Accordingly, the device key created by device 102 in step 528 differs from the device key created in step 504.

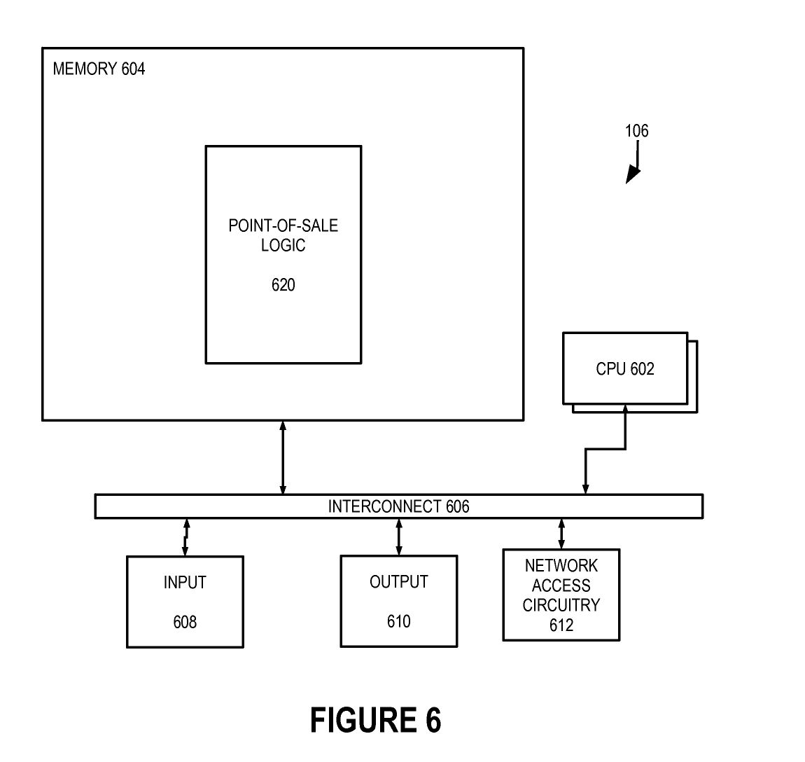

Point-of-sale equipment 106 is shown in greater detail in FIG. 6. Point-of-sale equipment 106 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional interconnect 606, which is a bus in this illustrative embodiment and which connects CPU 602 and memory 604 to one or more input devices 608, output devices 610, and network access circuitry 612. Input devices 608 can include, for example, a keyboard, a keypad, a touch-sensitive screen, a mouse, a microphone, and one or more cameras. Output devices 610 can include, for example, a display—such as a liquid crystal display (LCD)—and one or more loudspeakers. Network access circuitry 612 sends and receives data through computer networks such as wide area network 104 (FIG. 1).

A number of components of point-of-sale equipment 106 are stored in memory 604. In particular, point-of-sale logic 620 is all or part of one or more computer processes executing within CPU 602 from memory 604 in this illustrative embodiment but can also be implemented using digital logic circuitry.

Transaction server 108 is shown in greater detail in FIG. 7. Transaction server 108 includes one or more microprocessors 702 (collectively referred to as CPU 702), memory 704, a conventional interconnect 706, and network access circuitry 712, which are directly analogous to CPU 602 (FIG. 6), memory 604, conventional interconnect 606, and network access circuitry 612, respectively.

A number of components of transaction server 108 (FIG. 7) are stored in memory 704. In particular, transaction server logic 720 is all or part of one or more computer processes executing within CPU 702 from memory 704 in this illustrative embodiment but can also be implemented using digital logic circuitry. Known device data 730 and transaction data 732 are data stored persistently in memory 704. In this illustrative embodiment, known device data 730 and transaction data 732 are each organized as all or part of one or more databases. Known device data 730 stores attribute data of known devices for user and device authentication in the manner described above. Transaction data 732 stores transaction records, such as transaction record 400 (FIG. 4), for management of transactions in the manner described above.

Device 102 is a portable personal computing device and is shown in greater detail in FIG. 8. Device 102 includes one or more microprocessors 802 (collectively referred to as CPU 802) that retrieve data and/or instructions from memory 804 and execute retrieved instructions in a conventional manner. Memory 804 can include generally any computer-readable medium including, for example, persistent memory such as magnetic and/or optical disks, ROM, and PROM and volatile memory such as RAM.

CPU 802 and memory 804 are connected to one another through a conventional interconnect 806, which is a bus in this illustrative embodiment and which connects CPU 802 and memory 804 to one or more input devices 808, output devices 810, and network access circuitry 812. Input devices 808 can include, for example, a keyboard, a keypad, a touch-sensitive screen, a mouse, a microphone, and one or more cameras. Output devices 810 can include, for example, a display—such as a liquid crystal display (LCD)—and one or more loudspeakers. Network access circuitry 812 sends and receives data through computer networks such as wide area network 104 (FIG. 1).

A number of components of device 102 are stored in memory 804. In particular, transaction client logic 820 and digital fingerprint generator 840 are each all or part of one or more computer processes executing within CPU 802 from memory 804 in this illustrative embodiment but can also be implemented using digital logic circuitry. As used herein, “logic” refers to (i) logic implemented as computer instructions and/or data within one or more computer processes and/or (ii) logic implemented in electronic circuitry.

Transaction client logic 820 interacts with the user of device to facilitate transactions in the manner described above. Digital fingerprint generator 840 facilitates authentication of device 102 in the manner described above.

Operating system 830 is all or part of one or more computer processes executing within CPU 1402 from memory 804 in this illustrative embodiment but can also be implemented using digital logic circuitry. An operating system (OS) is a set of programs that manage computer hardware resources and provide common services for application software such as transaction client logic 820 and digital fingerprint generator 840.

Digital fingerprint 842 is data stored persistently in memory 804 and can be organized as all or part of one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for conducting a transaction with a remotely located device, the method comprising:
in a first session:
receiving a transaction request from the device; and
sending first authentication data to the device;
in a second session, that is different from the first session:
encrypting initial token data using second authentication data and the first authentication data to produce encrypted token data;
sending the encrypted token data and the second authentication data to the device;
receiving decrypted token data that is the result of decrypting the encrypted token data using the first and second authentication data;
determining that the decrypted token data matches the initial token data; and
in response to determining that the decrypted token data matches the initial token data, effecting the transaction.

2. The method of claim 1 wherein sending the encrypted token data comprises:
sending the encrypted token data to point-of-sale equipment for communication of the encrypted token data to the device.

3. The method of claim 2 wherein receiving decrypted token data comprises:
receiving the decrypted token data from the point-of-sale equipment.

4. The method of claim 1 further comprising:
sending a transaction identifier to the device in the first session;
receiving the transaction identifier from point-of-sale equipment in the second session;
determining that the transaction request identifies a location associated with the point-of-sale equipment; and
performing the effecting of the transaction only upon a condition in which the transaction request identifies the location associated with the point-of-sale equipment.

5. The method of claim 1 wherein effecting the transaction comprises:
causing an automated teller machine to dispense cash in an amount specified in the transaction request.

6. A tangible computer readable medium useful in association with a computer that includes one or more processors and a memory, the computer readable medium including computer instructions that are configured to cause the computer, by execution of the computer instructions in the one or more processors from the memory, to conduct a transaction with a remotely located device by at least:
in a first session:
receiving a transaction request from the device; and
sending first authentication data to the device;
in a second session, that is different from the first session:
encrypting initial token data using second authentication data and the first authentication data to produce encrypted token data;
sending the encrypted token data and the second authentication data to the device;
receiving decrypted token data that is the result of decrypting the encrypted token data using the first and second authentication data;
determining that the decrypted token data matches the initial token data; and
in response to determining that the decrypted token data matches the initial token data, effecting the transaction.

7. The computer readable medium of claim 6 wherein sending the encrypted token data comprises:
sending the encrypted token data to point-of-sale equipment for communication of the encrypted token data to the device.

8. The computer readable medium of claim 7 wherein receiving decrypted token data comprises:
receiving the decrypted token data from the point-of-sale equipment.

9. The computer readable medium of claim 6 where the computer instructions are configured to cause the computer to conduct a transaction with a remotely located device by at least also:
sending a transaction identifier to the device in the first session;
receiving the transaction identifier from point-of-sale equipment in the second session;
determining that the transaction request identifies a location associated with the point-of-sale equipment; and
performing the effecting of the transaction only upon a condition in which the transaction request identifies the location associated with the point-of-sale equipment.

10. The computer readable medium of claim 6 wherein effecting the transaction comprises:
causing an automated teller machine to dispense cash in an amount specified in the transaction request.

11. A computer system comprising:
at least one processor;
a computer readable medium that is operatively coupled to the processor;
network access circuitry that is operatively coupled to the processor; and
transaction management logic (i) that executes at least in part in the processor from the computer readable medium and (ii) that, when executed, causes the processor to conduct a transaction with a remotely located device by at least:
in a first session:
receiving a transaction request from the device; and
sending first authentication data to the device;
in a second session, that is different from the first session:
encrypting initial token data using second authentication data and the first authentication data to produce encrypted token data;
sending the encrypted token data and the second authentication data to the device;
receiving decrypted token data that is the result of decrypting the encrypted token data using the first and second authentication data;
determining that the decrypted token data matches the initial token data; and
in response to determining that the decrypted token data matches the initial token data, effecting the transaction.

12. The computer system of claim 11 wherein sending the encrypted token data comprises:
sending the encrypted token data to point-of-sale equipment for communication of the encrypted token data to the device.

13. The computer system of claim 12 wherein receiving decrypted token data comprises:
receiving the decrypted token data from the point-of-sale equipment.

14. The computer system of claim 11 where the transaction management logic causes the processor to conduct a transaction with a remotely located device by at least also:
sending a transaction identifier to the device in the first session;
receiving the transaction identifier from point-of-sale equipment in the second session;
determining that the transaction request identifies a location associated with the point-of-sale equipment; and
performing the effecting of the transaction only upon a condition in which the transaction request identifies the location associated with the point-of-sale equipment.

15. The computer system of claim 11 wherein effecting the transaction comprises:
causing an automated teller machine to dispense cash in an amount specified in the transaction request.
